(19) United States
(12) Patent Application Publication
(10) Pub. No.: US 2013/0321914 A1
(43) Pub. Date: Dec. 5, 2013

(54) FABRICATION METHOD OF TRANSPARENT RESIN SUBSTRATE ALONG WITH TRANSPARENT RESIN SUBSTRATE

(71) Applicant: Takuji MIZUNO, Sabae-shi (JP)

(72) Inventor: Takuji MIZUNO, Sabae-shi (JP)

(73) Assignees: TONY OPTICAL ENTERPRISES CO., LTD., Taipei (TW); MAGTIC INC., Sabae-shi, (JP)

(21) Appl. No.: 13/482,373

(22) Filed: May 29, 2012

(51) Int. Cl. C08L 69/00; B29D 11/00; G02B 5/30; C08K 5/3467

(52) U.S. Cl. 359/483.01; 524/88; 264/1.1; 264/1.34

(57) ABSTRACT

A fabrication method of a transparent resin substrate, includes the steps of melting a resin; mixing the resin with a first, second, and third Phthalocyanine pigments in the order respectively, each having a minimum value of a spectral transmission curve with a transmittance less than 10% within 800 nm.-850 nm wavelength, 950 nm-1.000 nm wavelength, and 875 nm-925 nm wavelength respectively; injection molding of the mixed resin in a cavity; and obtaining a transparent resin substrate having an overall spectral transmission curve having within 800 nm-1000 nm wavelength a minimum value area with a transmittance less than 5%. An overall weight portion of the first Phthalocyanine pigment, the second Phthalocyanine pigment and the third Phthalocyanine pigment compared to the total substrate weight of the transparent resin substrate is in the range of 1 ppm-500 ppm.

The present invention relates generally to a transparent resin substrate used for glasses lenses, and more particularly to an innovative one which involves the preparation method of transparent resin substrate with a minimum transmittance less than 5% in the wavelength of 800 nm-1000 nm.

Glasses can be used to correct the eyesight and protect the eyes from. harmful infrared or ultraviolet light; so sunglasses have to be added with UV absorbent or IR absorbent for preventing UV or IR transmission. Such glasses are disclosed in JP 2007-271744 and in JP 2000-7871.

Transparent resin substrate made of MMA (methyl methacrylate) resin, acrylic, PC (polycarbonate) resin, or nylon is preferably Used for glasses lenses, however, PC of stronger impact resistance is a preferred option of glasses lenses in view of relatively poor impact resistance of MMA; but PC requires a molding temperature over 250 C, so conventional IR absorbent may lead to degradation or decomposition, making it impossible to acquire lenses of excellent IR absorbance and impact resistance.

The objective of the present invention is to provide a glasses lens that can block off efficiently specific wavelength in sunlight, especially 800 nm -1000 nm infrared ray; so polycarbonate (PC) resin, etc, of excellent impact resistance can be applied to the fabrication method of transparent resin substrate, thereby fabricating transparent resin substrate.

The present invention is focuses on Phthalocyanine pigment that's not easily decomposed. even in high temperature; with different molecule structures, Phthalocyanine pigment's threshold of absorbing wavelength may vary in 800 nm-1000 nm; yet, the existing Phthalocyanine pigment's threshold range is extremely narrow, and the transmittance is also approx. 10%; by mixing properly Phthalocyanine pigments of different molecule structures, namely, mixing Phthalocyanine pigments of threshold within 800 nm-1000 nm on the spectral transmission curve, it is possible to fabricate transparent resin substrate of targeted spectral transmission curve.

As defined in Claim 1 a fabrication method of a transparent resin substrate comprises the steps melting a resin, mixing said resin with a first Phthalocyanine pigment (A) comprising a first minimum value of a spectral transmission curve with a transmittance less than 10% within 800 nm-850 nm wavelength; mixing said resin with a second Phthalocyanine pigment (B) comprising a second minimum value of a spectral transmission curve with a transmittance less than 10% within 950 nm-1000 nm wavelength; mixing said resin with a third Phthalocyanine pigment (C) comprising a third minimum value of a spectral transmission curve with a transmittance less than 10% within 875 nm-925 nm wavelength; injection molding of said mixed resin in a cavity; and obtaining a transparent resin substrate comprising an overall spectral transmission curve having within 800 nm-1000 nm wavelength a minimum value area with a transmittance less than 5%, wherein an overall weight portion of the first Phthalocyanine pigment (A), the second Phthalocyanine pigment (B) and the third Phthalocyanine pigment (C) compared to the total substrate weight of the transparent resin substrate is in the range of 1 ppm-500 ppm. Phthalocyanine pigments (A), (B), (C) represent one or several types.

As defined in claim 2, the transparent resin substrate is provided with one of the groups of polarizing and dimming means.

The preferred embodiment of said resin is shown by polycarbonate resin defined in claim 3; moreover, the specific value of Phthalocyanine pigment (A), (B), (C) is as follows: 160 ppm-170 ppm for Phthalocyanine pigment (A), 185 ppm-195 ppm for (B), and 160 ppm-170ppm for (C).

As defined in claim 4, said transparent resin substrate comprises a resin that is injection molded by the melted resin, comprising a weight portion of the first Phthalocyanine pigment (A) compared to the substrate weight is 160 ppm-170 ppm, the weight portion of the second Phthalocyanine pigment (B) compared to the substrate weight is 185 ppm-195 ppm, and the weight portion of the third Phthalocyanine pigment (C) compared to the substrate weight is 160 ppm-170 ppm. Phthalocyanine pigments (A), (B), (C) represent one or several types.

As defined in claim 5, said transparent resin substrate is provided with one of the groups of polarizing and dimming means.

The preferred embodiment of said resin is shown by polycarbonate resin defined in claim 6; moreover, the weight portion of Phthalocyanine pigments (A), (B), (C) compared to the substrate weight is 160 ppm-170 ppm for the first Phthalocyanine pigment (A), 185 ppm-195ppm for the second Phthalocyanine pigment (B), and 160 ppm-170 ppm for the third Phthalocyanine pigment (C).

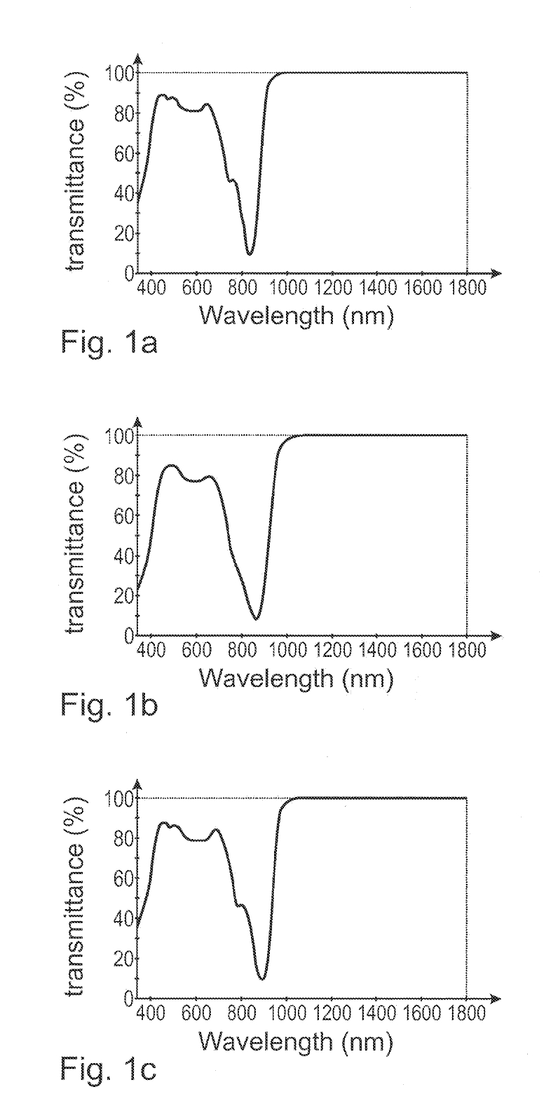

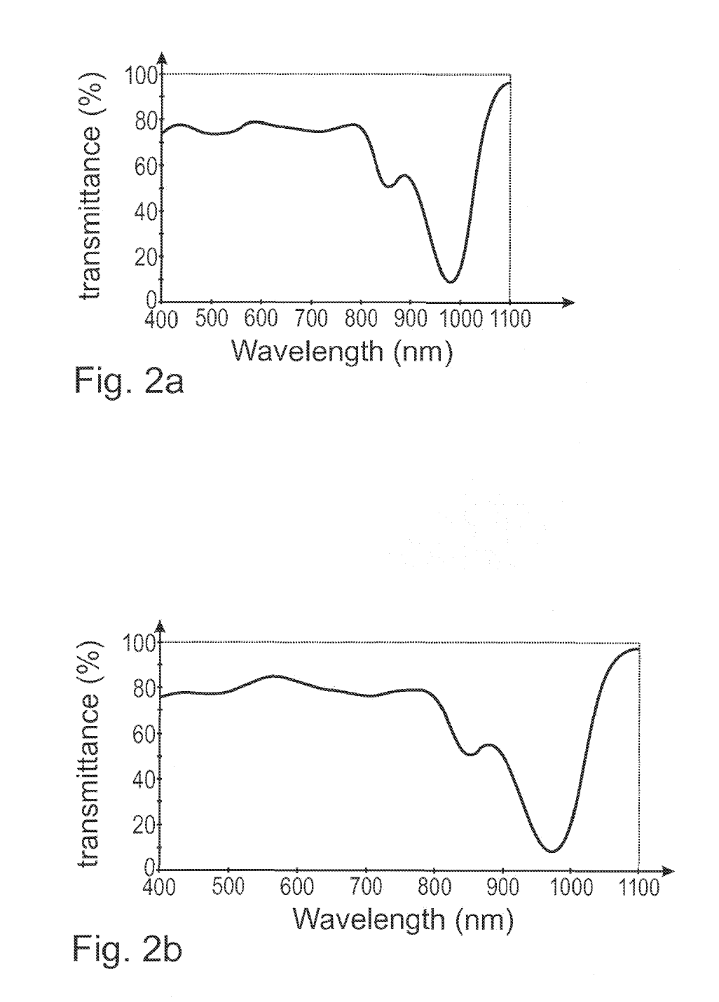

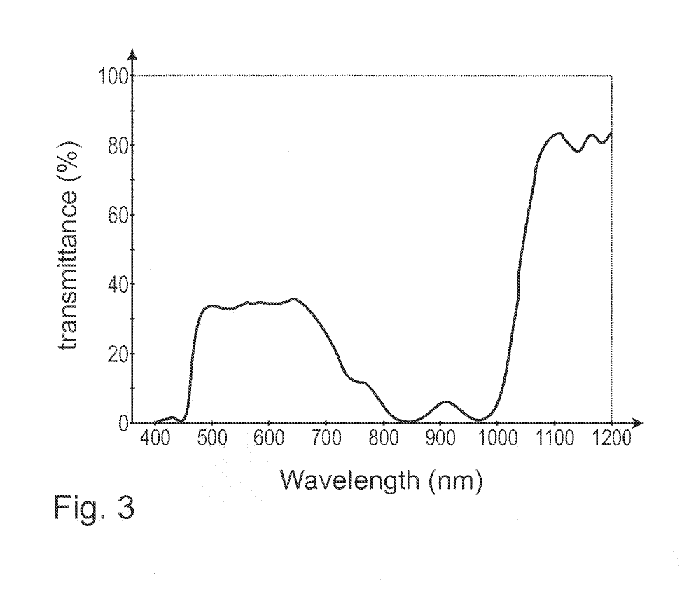

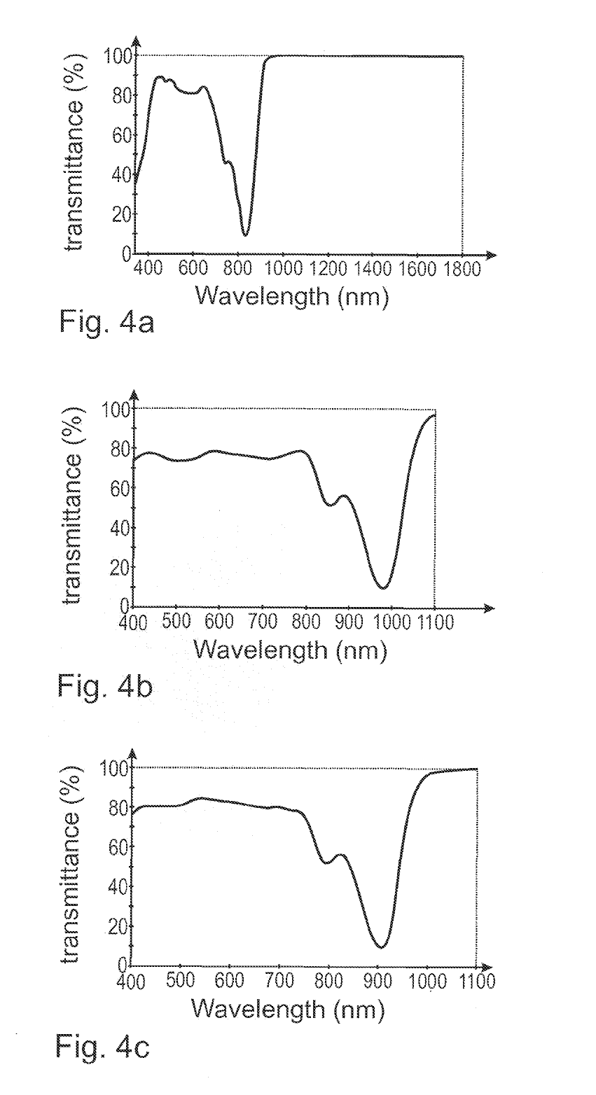

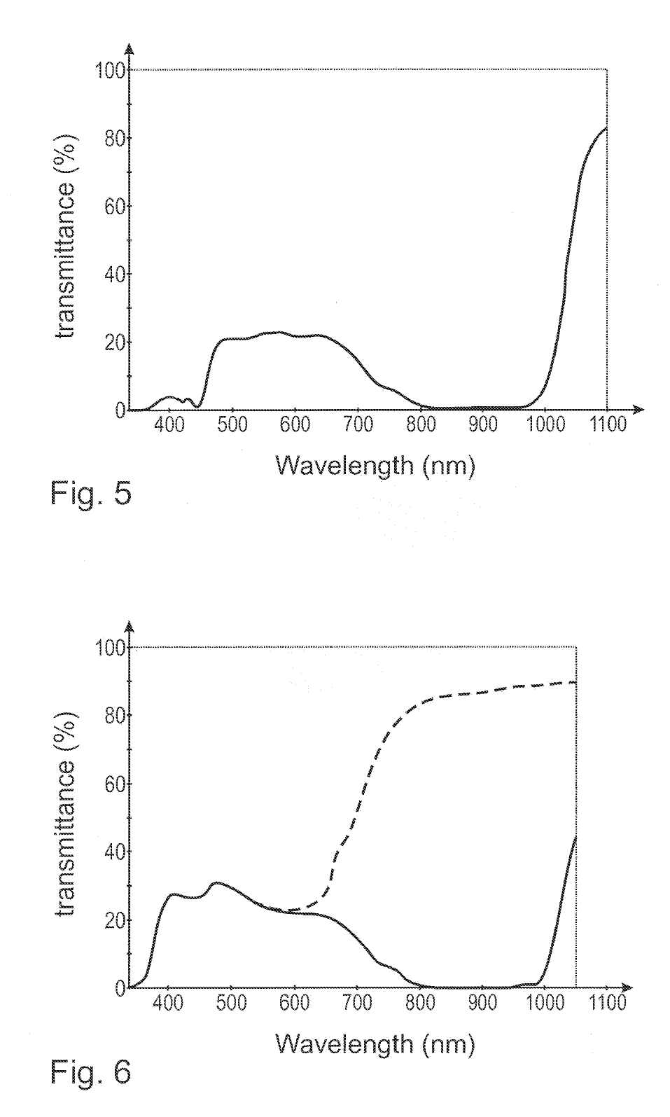

As shown in claim 7, the transparent resin substrate is provided with eyesight correction means.

[FIG. 1] (a)-(c) depict a transmittance spectrogram showing mixture of toluene solvent at 5% weight with Phthalocyanine pigments of different molecule structures.

[FIG. 2] (a), (b) depict a transmittance spectrogram showing mixture of toluene solvent at 5% weight with Phthalocyanine pigments of different molecule structures.

[FIG. 3] depicts a transmittance spectrum of mixing properly Phthalocyanine pigments of different structures within the weight of 1 ppm-500 ppm.

[FIG. 4] (a)-(c) depict a transmittance spectrogram of Phthalocyanine pigment of the preferred embodiment of the present invention. [FIG. 5] depicts a transmittance spectrogram of transparent resin substrate of the preferred embodiment of the present invention; [FIG. 6] depicts a transmittance spectrogram of transparent. resin substrate of the present invention which is engineered with polarizing functions.

The present invention can provide a transparent resin substrate that can block off efficiently specific wavelength in sunlight, especially 800 nm-1000 nm infrared ray.

The preferred embodiment of the present invention is described with a reference to the following drawings: The melted resin for the transparent resin substrate of the present invention can be injection molded from the cavity to form transparent resin substrate of outstanding transparency; notwithstanding Diethylene glycol bis-allyl carbonate (CR-39), polymethyl. methacrylate (PMMA) and methyl methacrylate (MMA) can be used, the resin of the present invention melted over 250 C is a preferred option, for instance: polycarbonate (PC) resin;

The following is a detailed description of PC resin.

Phthalocyanine pigment is a well-known pigment that can absorb IR ray, and its threshold of absorbing wavelength may vary due to different molecule structures; as shown in FIG. 1, there are currently available with Phthalocyanine pigments of different thresholds of absorbing wavelength for various purposes;

One example of the currently available Phthalocyanine pigment is represented by “EX Color” made by Nippon Shokubai Co., Ltd; Said. Phthalocyanine pigment is dissolved by the solvent such as methyl ethyl ketone or 2-butane and toluene; in such state, the transmittance spectrum can be analyzed by the solvent; FIGS. 1 and 2 depict the transmittance spectrum showing' mixture of toluene solvent; at 5% weight with Phthalocyanine pigments of different molecule structures;

The Phthalocyanine pigment of the present invention has a minimum value of spectral transmission curve with a transmittance less than 10%, at 800 nm-1000 nm wavelength;

FIGS. 1 and 2 depict the preferred embodiments of Phthalocyanine pigment.

Referring to FIG. 1(a), Phthalocyanine pigment around 820 nm has a threshold with a transmittance less than 10%; referring to FIG. 1(b), Phthalocyanine pigment, around 850 nm has a threshold with a transmittance less than 10%; referring to FIG. 1(c), Phthalocyanine pigment around 880 nm has a threshold with a transmittance less than 10%; referring also to FIG. 2(a), Phthalocyanine pigment around 970 nm has a threshold with a transmittance less than 10%; referring to FIG. 2(b), Phthalocyanine pigment around 980 nm has a threshold with a transmittance less than 10%.

Amongst Phthalocyanine pigments shown in FIGS. 1 and 2, over two pigments of different thresholds at 1 ppm-500 ppm are melted and mixed into 250 C-300 C polycarbonate; in the case of less than 1 ppm, IR ray is almost not absorbed; in the case of excess of 500 ppm, Visible light may be blocked off; in the range of visible light (approx. 500 nm -700 nm wavelength), the lower limit of permitted transmittance is about 15%.

The available combinations are listed below: Phthalocyanine pigment around 820 nm with a transmittance less than 10% as shown in FIG. 1(a); Phthalocyanine pigment around 980 nm with a transmittance less than 10% as shown in FIG. 2(a) or FIG. 2(b); and Phthalocyanine pigment around 880 nm with a transmittance less than 10% as shown in FIG. 1(c).

Thus, the transmittance of visible light is guaranteed to be within a spectral transmission curve over 15%, and the standard mixed. amount can be obtained experimentally; for instance, within 1 ppm-500 ppm weight, Phthalocyanine pigments of different structures are mixed properly (e.g. by 150 ppm), with the spectral transmission curve of the transparent resin substrate shown in FIG. 3; in this transmittance spectrum, high IR absorbing energy less than 59% may occur around 800 nm-880 nm and 970 nm, about 10% peak around 900 nm, and then a sharp spectral transmission curve may occur from 970 nm to form an overall waveform.

In such case, within the weight range of 1 ppm-500 ppm, Phthalocyanine pigment with a threshold around 900 nm and 970 nm may be properly added or increased; next, transmittance spectrum is obtained for the transparent resin substrate to analyze the spectral transmission curve; by repeating these steps, it is possible to determine the optimum combination of Phthalocyanine pigments; furthermore, given the higher price of Phthalocyanine pigment, the amount of Phthalocyanine pigment shall be reduced to obtain the lowest-cost combination after reaching the intended spectral transmission curve.

The aforementioned Phthalocyanine pigment combinations are mixed into polycarbonate melted at 250 C-300 C, then the mixed solvent is injected into the cavity to obtain a transparent resin substrate that has a flat minimum value area with a transmittance less than 5%, and spectral transmission curve at 800 nm-1000 nm. wavelength; this transparent resin substrate can be used as optical instruments such as lens or filters, or molded into the glasses lenses of excellent IR absorbance with preset size and shape.

The transparent resin substrate of the present invention can also be provided. with polarizing and/or dimming or eyesight correction functions; additionally, other pigments or additives can be added where necessary.

The materials for the preferred embodiment of the present invention are listed below: Resin: transparent polycarbonate (H3000U made by Mitsubishi Chemical), 100 kg

Phthalocyanine pigment (A): “EX Color” IR14 made by Nippon Shokuhai Co., Ltd. (maximum absorption wavelength is 832 nm when 5% weight is melted in chloroform solvent, as shown in FIG. 4(a))

Range: 16.0 g-17.0 g

Phthalocyanine pigment (B): the same with IR910 (maximum absorption wavelength is 977 nm when 5% weight is melted in chloroform solvent, as shown in FIG. 4(b))

Range 18.5 g-19.5 g

Phthalocyanine pigment (C): the same with IR20 (maximum absorption wavelength is 904 nm when 5% weight is melted in chloroform solvent, as shown in FIG. 4(c))

Range: 16.0 g-17.0 g

After melting and mixing at 300 C, said materials is injection molded into a transparent resin substrate;

FIG. 5 depicts a transmittance spectrum of transparent resin substrate (glasses lenses) when the aforementioned. (A), (B), (C) are defined at 16.5 g, 19.0 g, 16.5 g in the center of the range; the transparent resin substrate has a flat minimum value area with a transmittance less than 5% (almost 0), at the spectral transmission curve of 800 nm-1000 nm.

FIG. 6 depicts a preferred embodiment of the transparent resin substrate (glasses lenses) of polarizing functions suitable for the present invention;

A broken line represents the spectral transmission curve of transparent resin substrate of polarizing functions; a polarizer can be adhered onto at least one surface of the transparent resin substrate: a common transparent resin substrate of polarizing functions cannot inhibit IR transmission functions, enabling to transmit over 90% of 800 nm-1000 nm wavelength;

Once IR absorption functions of the present invention are applied, to the transparent resin substrate of polarizing functions, it is possible to obtain a transparent resin substrate which has a flat minimum value area with a transmittance less than 5% (almost 0), at the spectral transmission curve of 800 nm-1000 nm.

The present invention is not limited to the aforementioned preferred embodiment;

For instance, the transparent resin substrate of the present invention can be provided with polarizing and/or dimming functions, and especially eyesight correction functions for glasses lenses;

In addition, at the overall weight of 1 ppm 500 ppm, there are Phthalocyanine pigment (A)within 800 nm -850 nm wavelength, and. with a minimum value of spectral transmission curve with a transmittance less than 10%; Phthalocyanine pigment (B)within 950 nm-1000 nm wavelength, and with a minimum value of spectral transmission curve with a transmittance less than 10%; and Phthalocyanine pigment (C) within 875 nm-925 nm wavelength, and with a minimum value of spectral transmission curve with a transmittance less than 10%; Phthalocyanine pigment (A), (B), (C) represent one or several types.

Furthermore, Phthalocyanine pigment or other pigments or additives can be added into the resin.

The transparent resin substrate of the present invention can be widely applied to common glasses, sunglasses (with polarizing or dimming functions), fronthung glasses and goggles as well as other optical instruments such as filters.

What is claimed is:

1. A fabrication method of a transparent resin substrate, comprising the steps:
melting a resin,
mixing said resin with a first Phthalocyanine pigment (A) comprising a first minimum value of a first spectral transmission curve with a transmittance less than 10% within 800 nm -850 nm wavelength;
mixing said resin with a second Phthalocyanine pigment (B) comprising a second minimum value of a second spectral transmission. curve with a transmittance less than 10% within 950 nm-1000 nm wavelength;
mixing said resin With a third Phthalocyanine pigment (C) comprising a third minimum value of a third spectral transmission curve with a transmittance less than 10% within 875 nm-925 nm wavelength;
injection molding of said mixed resin in a cavity; and
obtaining a transparent resin substrate comprising an overall spectral transmission curve having within 800 nm-1000 nm wavelength a minimum value area with a transmittance less than 5%,
wherein an overall weight portion of the first Phthalocyanine pigment (A), the second Phthalocyanine pigment (B) and the third Phthalocyanine pigment (C) compared to the total substrate weight of the transparent resin substrate is in the range of 1 ppm -500 ppm.

2. The method defined in claim 1, characterised by the transparent resin substrate is provided with at least one of the group of polarizing and dimming in cans.

3. The method defined in claim 1, wherein said resin is a polycarbonate (PC) resin, the weight portion of the first Phthalocyanine pigment (A) compared to the substrate weight is 160 ppm-170 ppm, the weight portion of the second Phthalocyanine pigment (B) compared to the substrate weight is 185 ppm-195 ppm for (B), and the weight portion of the third Phthalocyanine pigment (C) compared to the substrate weight is 160 ppm-170 ppm for (C).

4. A transparent resin substrate, characterized in that, a resin is injection molded by the melted resin in a cavity, comprising:
a. a first Plithalocyanine pigment (A) comprising a first minimum value of a first spectral transmission curve with a transmittance less than 10% within 800 nm-850 nm wavelength;
b. a second Phthalocyanine pigment (B) comprising a second minimum value of a second spectral transmission curve with a transmittance less than 10% within 950 nm-1000 nm wavelength;
and
c. a third Phthalocyanine pigment (C) comprising a third minimum value of a third spectral transmission curve with a transmittance less than 10% within 875 nm-925 nm wavelength,
wherein the overall weight portion of said three Phthalocyanine pigments (A, B, C) compared to a total substrate weight of the transparent resin substrate is in the range of 1 ppm-500 ppm, so the spectral transmission curve of the transparent resin substrate has a minimum value area with a transmittance less than 5% within 800 nm-1000 nm wavelength.

5. The substrate defined in claim 4, wherein said transparent resin substrate is provided with at least one of the group polarizing and dimming means, in particular a polarizer is adhered onto at least one surface of the transparent resin substrate.

6. The substrate defined in claim 4, wherein said resin is a polycarbonate (PC) resin, the weight portion of the first Phthalocyanine pigment (A) compared to the substrate weight is 160 ppm-170 ppm, the weight portion of the second Phthalocyanine pigment (B) compared to the substrate weight is 185 ppm-195 ppm, and the weight portion of the third Phthalocyanine pigment (C) compared to the substrate weight is 160 ppm-170 ppm.

7. The substrate defined in claim 4, wherein said transparent resin substrate is provided with eyesight correction means.
